(19) United States
(12) Patent Application Publication
(10) Pub. No.: US 2014/0226216 A1
(43) Pub. Date: Aug. 14, 2014

(54) COMPOSITE OPTICAL ELEMENT

(71) Applicant: Panasonic Corporation, Osaka (JP)

(72) Inventor: Nobuyuki KOBAYASHI, Hyogo (JP)

(73) Assignee: Panasonic Corporation, Osaka (JP)

(21) Appl. No.: 14/257,534

(22) Filed: Apr. 21, 2014

Related U.S. Application Data
(62) Division of application No. 13/367,921, filed on Feb. 7, 2012.

(30) Foreign Application Priority Data
Feb. 15, 2011 (JP) 2011-029356
Dec. 7, 2011 (JP) 2011-268290

(51) Int. Cl. G02B 1/04

(52) U.S. Cl. CPC G02B 1/041
USPC 359/642

(57) ABSTRACT

The present invention provides a resin composition for a composite optical element including: a first (meth)acrylate having a fluorene skeleton; and a second (meth)acrylate having a biphenyl ring but having no hydroxyl group. In the resin composition, the content of the first (meth)acrylate is 4 to 42 wt %.

### BACKGROUND OF THE INVENTION

1. Field of the Invention

The present invention relates to a composite optical element in which a resin layer is stacked on a lens substrate, and a resin composition for a composite optical element used for the resin layer. The present invention also relates to an imaging device and an optical recording and reproducing device each including the composite optical element.

2. Description of Related Art

A structure in which a resin layer is stacked on a lens substrate made of a material such as glass is generally called a composite optical element. Such a resin layer is composed of various compounds depending on the intended application of the composite optical element.

For example, JP 2010-37470 A discloses a composition that includes a compound having a (meth)acryloyloxy group and a fluorene ring, a compound having one or more (meth)acryloyl groups or vinyl groups but having no fluorene ring in one molecule, and a polymerization initiator, and also discloses an optical element.

However, the composition disclosed in JP 2010-37470 A may cause problems concerning the viscosity and the cure shrinkage of the resin composition. The composite optical element is formed by applying a resin composition onto a lens substrate and thereafter curing the resin composition. Excessively high viscosity of the resin composition makes, in the case of the presence of air bubbles in the resin composition, the air bubbles difficult to be released. Therefore, the thus formed composite optical element is rendered defective. Meanwhile, excessively high cure shrinkage of the resin composition may cause the resin layer formed on the lens substrate to be separated at the time of curing the resin composition.

Further, the optical element of JP 2010-37470 A does not have a diffraction grating formed at the interface between the lens substrate and the resin layer. In the case of forming a composite optical element having a diffraction grating formed at the interface between the lens substrate and the resin layer, a diffracted beam is generated when an optical beam passes through the diffraction grating. In order to enhance the diffraction efficiency of the diffracted beam, combination between the optical constants of the lens substrate and the optical constants of the resin layer is important. Therefore, a resin composition having optical constants that are optimal with respect to the optical constants of the lens substrate is required.

### SUMMARY OF THE INVENTION

It is an object of the present invention to provide a resin composition for a composite optical element that has low viscosity and low cure shrinkage while satisfying desired optical constants.

The present invention is represented by a resin composition for a composite optical element that includes a first (meth)acrylate having a fluorene skeleton, and a second (meth)acrylate having a biphenyl ring but having no hydroxyl group, where the content of the first (meth)acrylate is 4 to 42 wt %.

According to the present invention, it is possible to provide a resin composition for a composite optical element that has low viscosity and low cure shrinkage, while satisfying desired optical constants.

### BRIEF DESCRIPTION OF THE DRAWINGS

FIG. 1 is a sectional view showing a composite optical element of the first embodiment.

FIG. 2 is a sectional view showing the outline of the process of producing the composite optical element of the first embodiment.

### DETAILED DESCRIPTION OF THE INVENTION

Hereinafter, the embodiments of the present invention are described with reference to the drawings.

### First Embodiment

### 1. Resin Composition

The resin composition of this embodiment includes, as essential components: (A) a first (meth)acrylate having a fluorene skeleton; and (B) a second (meth)acrylate having a biphenyl ring but having no hydroxyl group. In addition to these essential components, the resin composition of this embodiment may include other components, such as: (C) a third (meth)acrylate having a polyfunctional isocyanurate skeleton; (D) a fourth (meth)acrylate having a biphenyl ring and a hydroxyl group; and (E) a polymerization initiator. First, the respective components of the resin composition are described.

### (A) First (Meth)acrylate Having a Fluorene Skeleton

A (meth)acrylate having a fluorene skeleton, which serves as the first (meth)acrylate, has a structure resulted from esterification by a reaction between a fluorene compound and (meth)acrylic acid. The (meth)acrylate having a fluorene skeleton is a component that reduces the cure shrinkage of the composition, increases the refractive index of the cured composition, and decreases the Abbe number of the cured composition. The (meth)acrylate compound is preferably a (meth)acrylate compound having two (meth)acryloyl groups (di(meth)acrylate compound) from the viewpoint of curability of the composition. Further, it is preferably an acrylate compound from the viewpoint of curability.

As a (meth)acrylate having a fluorene skeleton, a compound represented by formula (1) is particularly preferable.

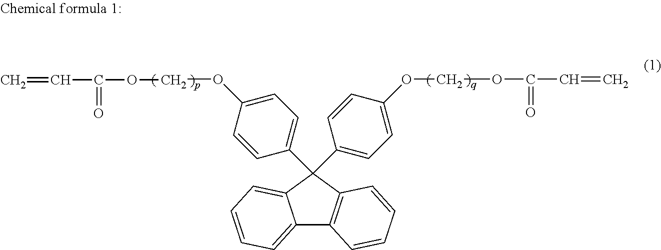

In the formula, p and q each denote a positive integer, and p+q is preferably 2 to 30, more preferably 2 to 20, further preferably 2 to 10.

Specific examples of the compound represented by formula (1) are shown below.

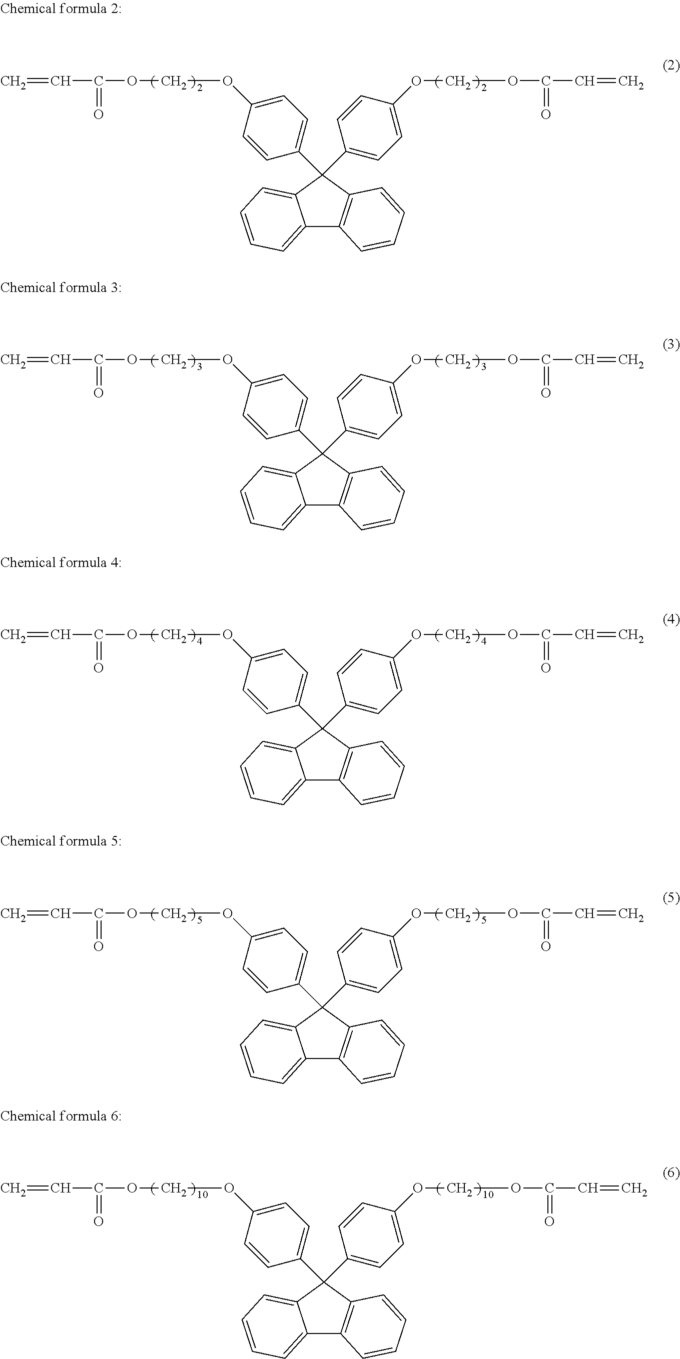

The content of the (meth)acrylate having a fluorene skeleton is 4 to 42 wt % when the entire resin composition is taken as 100 wt %. The content of less than 4 wt % results in excessively high cure shrinkage of the composition, and thus the content is preferably at least 5 wt %, more preferably at least 6 wt %, further preferably at least 7 wt %. On the other hand, the content of more than 42 wt % results in excessively high viscosity of the composition, and thus the content is preferably 40 wt % or less, more preferably 38 wt % or less, further preferably 35 wt % or less.

### (B) Second (Meth)acrylate Having a Biphenyl Ring but Having no Hydroxyl Group

A (meth)acrylate having a biphenyl ring but having no hydroxyl group, which serves as the second (meth)acrylate, has comparatively high refractive index and comparatively low cure shrinkage, while having low viscosity. Accordingly, it is possible to achieve low viscosity and low cure shrinkage while satisfying desired optical constants by combining the above-mentioned the first (meth)acrylate having a fluorene skeleton and the second (meth)acrylate having a biphenyl ring but having no hydroxyl group.

The (meth)acrylate having a biphenyl ring but having no hydroxyl group is preferably a (meth)acrylate compound having two (meth)acryloyl groups (di(meth)acrylate compound) from the viewpoint of the curability of the composition, while it is preferably a (meth)acrylate compound having one (meth)acryloyl group (mono(meth)acrylate compound) from the viewpoint of the viscosity. Further, it is preferably an acrylate compound from the viewpoint of the curability.

As the (meth)acrylate having a biphenyl ring but having no hydroxyl group, compounds represented by the following formulae (7) and (8), for example, can be used.

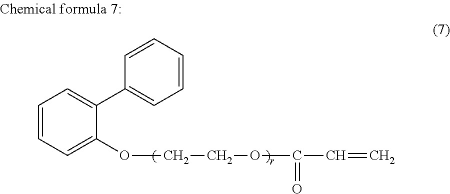

In the formula, r denotes a positive integer, and is preferably 1 to 15, more preferably 1 to 10.

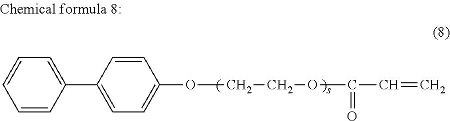

In the formula, s denotes a positive integer, and is preferably 1 to 15, more preferably 1 to 10.

Specific examples of the compound represented by formula (8) are shown below.

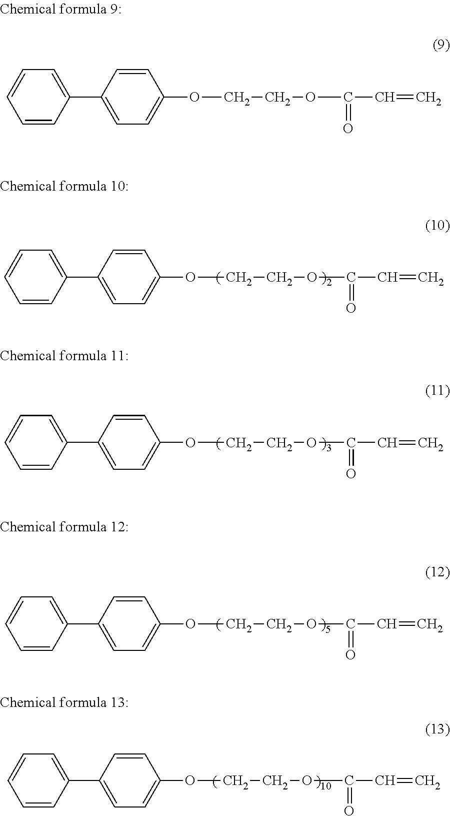

### (C) Third (Meth)acrylate Having a Polyfunctional Isocyanurate Skeleton

A (meth)acrylate having a polyfunctional isocyanurate skeleton, which serves as the third (meth)acrylate, has a greater effect in reducing the cure shrinkage of the composition than the second (meth)acrylate. It is preferably an acrylate compound from the viewpoint of the curability. As the (meth)acrylate having a polyfunctional isocyanurate skeleton, a compound represented by the following formula (14), for example, can be used.

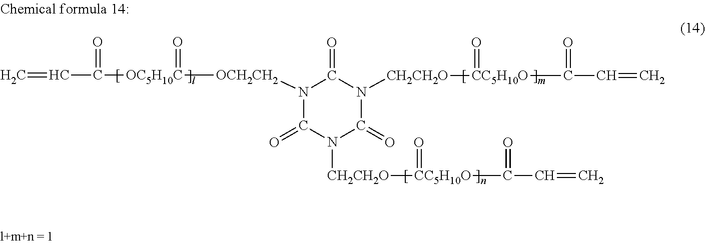

In the formula, l+m+n=0.7 to 2.5 is satisfied.

Specific examples thereof include compounds represented by the following formulae (15) to (17), but are not limited thereto.

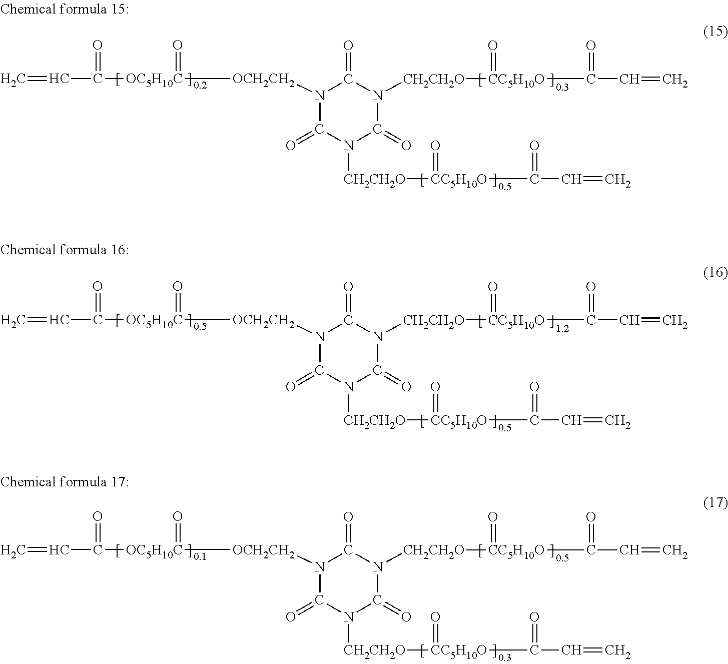

### (D) Fourth (Meth)acrylate Having a Biphenyl Ring and a Hydroxyl Group

A (meth)acrylate having a biphenyl ring and a hydroxyl group, which serves as the fourth (meth)acrylate, has a greater effect in reducing the cure shrinkage of the composition than the second (meth)acrylate, though it has higher viscosity. The (meth)acrylate having a biphenyl ring and a hydroxyl group is preferably a (meth)acrylate compound having two (meth)acryloyl groups (di(meth)acrylate compound) from the viewpoint of the curability of the composition, while it is preferably a (meth)acrylate compound having one (meth)acryloyl group (mono(meth)acrylate compound) from the viewpoint of the viscosity. Further, it is preferably an acrylate compound from the viewpoint of the curability. As the (meth)acrylate having a biphenyl ring and a hydroxyl group, a compound represented by the following formula (18), for example, can be used.

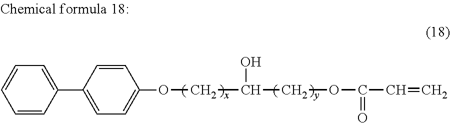

In the formula, x and y each denote a positive integer, and x+y is preferably 2 to 30, more preferably 2 to 20, further preferably 2 to 10.

Specific examples of the compound represented by formula (18) are shown below.

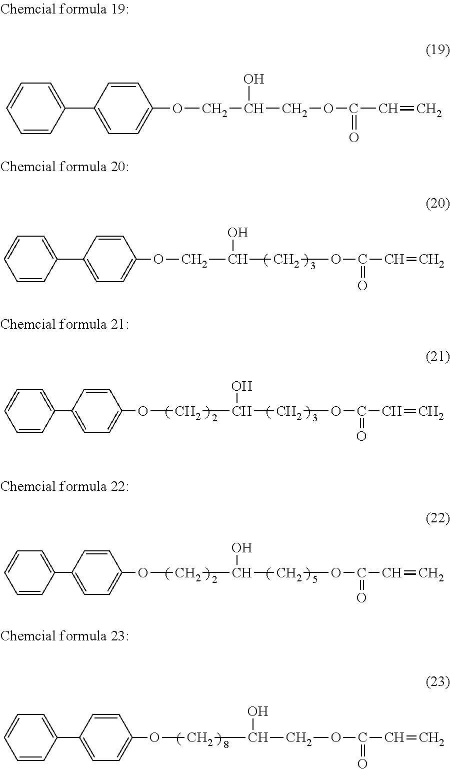

As the fourth (meth)acrylate, an epoxy (meth)acrylate compound represented by formula (24) is particularly preferable.

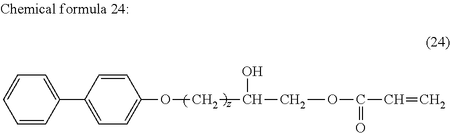

In the formula, z denotes a positive integer, and is preferably 1 to 29, more preferably 1 to 19, further preferably 1 to 9.

### (E) Polymerization Initiator

The type of the polymerization initiator (E) may be selected appropriately depending on the types of the component (A) to the component (D). A radical photopolymerization initiator can be used suitably.

As the radical photopolymerization initiator, known ones, such as radical photopolymerization initiators of acetophenone type, benzoin type, benzophenone type, thioxanthen type, acylphosphine oxide type, and hydroxyketone type, can be used. Specifically, 1-hydroxy-cyclohexyl-phenyl-ketone, 2-hydroxy-2-methyl-1-phenyl-propane-1-one, 2-[2-oxo-2-phenyl-acetoxy-ethoxy]-ethyl ester, 2,4,6-trimethylbenzoyl diphenylphosphine oxide, for example, can be mentioned. Further, the use of one with a high molecular weight, particularly, of oligomer type can improve the high temperature reliability of the optical element. Specifically, hydroxyketone compounds such as oligo{2-hydroxy-2-methyl-1-[4-(1-methylvinyl)phenyl]propanone} can be mentioned. The molecular weight in that case is preferably at least 250 but not more than 2000. The polymerization initiator can be used individually, or two or more types of them may be used in combination.

The content of the polymerization initiator is preferably at least 0.1 wt % but not more than 10 wt % when the entire resin composition is taken as 100 wt %. When the content of the photopolymerization initiator falls within this range, it is possible to form a resin layer by stable polymerization-curing without impairing the properties and the reliability of the resin composition.

Suitable combinations of the above-mentioned components (A) to (E) are shown below.

### <Resin Composition 1>

(A) First (meth)acrylate
(B) Second (meth)acrylate
(E) Polymerization initiator

In this case, it is preferable that the content of the component (A) be 4 to 42 wt %, the content of the component (B) be 48 to 94.9 wt %, and the content of the component (E) be 0.1 to 10 wt %.

Such a configuration leads to desired optical constants (refractive index and Abbe number), low viscosity, and low cure shrinkage in the formation of the resin layer.

### <Resin Composition 2>

(A) First (meth)acrylate
(B) Second (meth)acrylate
(C) Third (meth)acrylate
(E) Polymerization initiator

In this case, it is preferable that the content of the component (A) be 4 to 42 wt %, the total content of the components (B) and (C) be 48 to 95.9 wt %, and the content of the component (E) be 0.1 to 10 wt %.

Such a configuration leads to desired optical constants (refractive index and Abbe number), low viscosity, and low cure shrinkage in the formation of the resin layer.

### <Resin Composition 3>

(A) First (meth)acrylate
(B) Second (meth)acrylate
(D) Fourth (meth)acrylate
(E) Polymerization initiator

In this case, it is preferable that the content of the component (A) be 4 to 42 wt %, the total content of the components (B) and (D) be 48 to 95.9 wt %, and the content of the component (E) be 0.1 to 10 wt %.

Such a configuration leads to desired optical constants (refractive index and Abbe number), low viscosity, and low cure shrinkage in the formation of the resin layer.

### <Resin Composition 4>

(A) First (meth)acrylate
(B) Second (meth)acrylate
(C) Third (meth)acrylate
(D) Fourth (meth)acrylate
(E) Polymerization initiator

In this case, it is preferable that the content of the component (A) be 4 to 42 wt %, the total content of the components (B), (C), and (D) be 48 to 95.9 wt %, and the content of the component (E) be 0.1 to 10 wt %.

Such a configuration leads to desired optical constants (refractive index and Abbe number), low viscosity, and low cure shrinkage in the formation of the resin layer.

When the resin composition is irradiated with ultraviolet rays, polymerization is started particularly by an optional polymerization initiator, so that (A) first (meth)acrylate and (B) second (meth)acrylate, and additionally, optional (C) third (meth)acrylate, and optional (D) fourth (meth)acrylate are polymerized. Thus, the resin composition is cured to form the resin layer of the optical element.

The resin composition may include components other than the above-mentioned components (A) to (E) without impairing the effects of the present invention. For example, it may include another (meth)acrylate such as a (meth)acrylate containing a bicyclohexyl ring, other than the first to the fourth (meth)acrylates. Further, the resin composition may include a coupling agent, an ultraviolet absorber, a mold release agent, etc.

### 2. Composite Optical Element

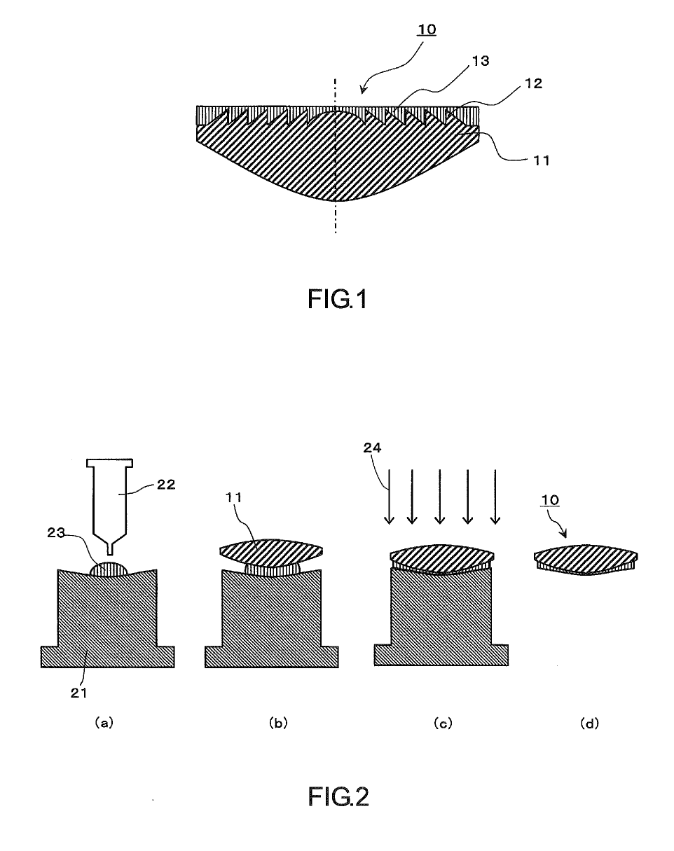

FIG. 1 is a sectional view showing the composite optical element of the first embodiment. The dashed-dotted line in FIG. 1 indicates the optical axis of a composite optical element 10. The composite optical element 10 has the shape of a rotating body formed by rotating, about the optical axis, the shape of the sectional view in FIG. 1. As shown in FIG. 1, the composite optical element 10 includes a lens substrate 11 having a diffraction grating 12, and a resin layer 13 stacked on the lens substrate 11. The diffraction grating 12 is located at the interface between the lens substrate 11 and the resin layer 13. The lens substrate 11 can be formed of a material such as glass, quartz, and ceramics. Among these, the lens substrate 11 made of glass is preferable because it matches best the optical properties of the resin layer 13. The resin layer 13 is formed of the cured product of the above-mentioned resin composition. In the first embodiment, only one surface of the lens substrate is convex, but both of the surfaces may be convex, or one or both of the surfaces may be concave. Moreover, the resin layer 13 may be formed on both surfaces of the lens substrate 11.

When the refractive index of the resin layer 13 is referred to as nd, and the Abbe number thereof is referred to as vd, 1.600≦nd≦1.615 and 22≦vd≦28 are preferably satisfied. In that case, the optical properties of the resin layer 13 match well the optical properties of the lens substrate 11, particularly a lens substrate made of glass.

Further, the thickness of the resin layer 13 may vary with location. By allowing the thickness of the resin layer 13 to vary with location, it is possible to fabricate, for example, an aspheric lens in which the resin layer 13 having an aspherical shape is provided on the lens substrate 11 having a spherical surface.

### 3. Production Method

Next, the method for producing the composite optical element is described. A production method using: (A) the first (meth)acrylate; (B) the second (meth)acrylate; and (E) the polymerization initiator as an example of the resin composition is described herein. The production method includes the steps of preparing a resin composition containing the above-mentioned components; and curing through polymerization the resin composition on a surface of a lens substrate. FIG. 2 shows the outline of the production method.

First, the step of preparing a resin composition is performed. Specifically, for example, the component (A), the component (B), and the component (E) are prepared. Then, these components are mixed together and degassed to prepare a resin composition 23.

The viscosity of the resin composition at 25° C. is preferably 2100 mPa·s or less, more preferably 1500 to 2000 mPa·s. When the viscosity exceeds 2100 mPa·s, air bubbles generated during mixing the components of the resin composition are difficult to remove, and thus air bubbles tend to remain in the resin layer.

Next, the step of curing through polymerization the resin composition on a surface of a lens substrate is performed. Specifically, for example, as shown in FIG. 2(a), the resin composition 23 is dropped from a dispenser 22 onto the surface of a mold 21 that has a shape corresponding to the shape of the resin layer of the composite optical element. Next, as shown in FIG. 2(b), the lens substrate 11 (in this example, one with both surfaces being convex is used and the diffraction grating present on the lower surface side is not shown) is put on the resin composition and a load is applied from the upper side of the lens substrate so as to spread the resin composition 23. Thereafter, as shown in FIG. 2(c), ultraviolet rays 24 are directed thereto with the lens substrate being set at a predetermined height relative to the mold 21, so that the resin composition is cured through polymerization. Through these steps, the composite optical element 10 in which the resin layer 13 is provided on the lens substrate 11 is obtained (FIG. 2(d)).

### Second Embodiment

The composite optical element of the first embodiment can be used for imaging devices such as cameras and video cameras, optical recording and reproducing devices, projectors, etc. in accordance with a publicly known method. The imaging devices including the composite optical element, the optical recording and reproducing devices including the composite optical element, and the projectors including the composite optical element allow an improvement in their optical properties, and a reduction in their size and weight.

### EXAMPLES

Hereinafter, the present invention is described in detail with reference to examples and comparative examples. However, the present invention is not limited to these examples.

For each of the examples and the comparative examples, Table 1 shows the composition of the resin composition, the shrinkage at the time of curing thereof, and the viscosity thereof, and further shows the refractive index of the cured product of the resin composition, the Abbe number thereof, and the transmittance thereof. Furthermore, Table 2 shows the transmittance after a high-temperature test at 85° C. for 500 hours (deterioration degree).

In these examples, the optical constants in which the cured product of the resin composition has a refractive index of at least 1.600 but not more than 1.615 and an Abbe number of at least 22 but not more than 28 were considered as desired optical properties. The refractive index and the Abbe number were measured using an Abbe refractometer for the cured product of the resin composition obtained by ultraviolet ray irradiation (3000 mJ/cm²).

The shrinkage ratio at the time of the polymerization-curing was calculated using the values of the specific gravities measured before and after the polymerization-curing by ultraviolet ray irradiation (3000 mJ/cm²). Specifically, the shrinkage ratio is the amount of change expressed by % in the specific gravity with reference to that before the polymerization-curing.

The viscosity (mPa·s) of the resin composition was measured at 25° C. using an E-type viscometer.

The transmittance was measured at 400 nm using a spectrophotometer for the cured product of the resin composition obtained by ultraviolet ray irradiation (3000 mJ/cm²). Further, after the cured product was allowed to stand in a high-temperature chamber maintained at 85° C. for 500 hours, the transmittance was measured and the deterioration degree was observed.

### Example 1

In this example, all of the following components (A), (B), and (E) were first mixed together to obtain a resin composition.
(A) First (meth)acrylate [Formula (2)]: 8 parts by weight
(B) Second (meth)acrylate [Formula (12)]: 92 parts by weight
(E) Photopolymerization initiator [Irgacure 754 (manufactured by BASF)]: 3 parts by weight

As shown in FIG. 2, the lens substrate was disposed on this resin composition. Irradiation with ultraviolet rays allowed the photopolymerization initiator to initiate polymerization of the components (A) and (B), and the components (A), (B) and (E) were cured through polymerization on the lens substrate to form a resin layer. Thus, the composite optical element of Example 1 having the structure shown in FIG. 1 was produced.

In this example, the refractive index was 1.606 and the Abbe number was 25.5, which were in an acceptable range. The shrinkage ratio at the time of curing was 3.6% and the viscosity was 250 mPa·s, which were sufficiently low. The transmittance was 85%, which was sufficiently high. As shown in Table 2, no deterioration was observed although the transmittance of the produced composite optical element after being allowed to stand at 85° C. for 500 hours was 83%, which decreased by 2%.

### Example 2

The difference from Example 1 was as follows.
(A) First (meth)acrylate [Formula (2)]: 35 parts by weight
(B) Second (meth)acrylate [Formula (12)]: 65 parts by weight

In this example, all of the following components (A), (B), and (E) were mixed together to obtain a resin composition. The lens substrate was disposed on this resin composition. Irradiation with ultraviolet rays allowed the photopolymerization initiator to initiate polymerization of the components (A) and (B), and the components (A), (B) and (E) were cured through polymerization on the lens substrate to form a resin layer. Thus, the composite optical element of Example 2 was produced.

In this example, the refractive index was 1.610 and the Abbe number was 23.8, which were in an acceptable range. The shrinkage ratio at the time of curing was 3.0%, which was sufficiently low. The viscosity was 1500 mPa·s, which was sufficiently low. The transmittance was 84%, which was sufficiently high.

### Comparative Example 1

The difference from Example 1 was as follows.
(A) First (meth)acrylate [Formula (2)]: 2 parts by weight
(B) Second (meth)acrylate [Formula (12)]: 98 parts by weight

In this comparative example, all of the following components (A), (B), and (E) were mixed together to obtain a resin composition. The lens substrate was disposed on this resin composition. Irradiation with ultraviolet rays allowed the photopolymerization initiator to initiate polymerization of the components (A) and (B), and the components (A), (B) and (E) were cured through polymerization on the lens substrate to form a resin layer. Thus, the composite optical element of Comparative Example 1 was produced.

In this comparative example, the refractive index was 1.600 and the Abbe number was 28, which were in an acceptable range. The viscosity was 200 mPa·s, which was sufficiently low, and the transmittance was 85.5%, which was sufficiently high. However, the shrinkage ratio at the time of curing was 4.5%, which was high.

### Comparative Example 2

The difference from Example 1 was as follows.
(A) First (meth)acrylate [Formula (2)]: 45 parts by weight
(B) Second (meth)acrylate [Formula (12)]: 55 parts by weight

In this comparative example, all of the following components (A), (B), and (E) were mixed together to obtain a resin composition. The lens substrate was disposed on this resin composition. Irradiation with ultraviolet rays allowed the photopolymerization initiator to initiate polymerization of the components (A) and (B), and the components (A), (B) and (E) were cured through polymerization on the lens substrate to form a resin layer. Thus, the composite optical element of Comparative Example 2 was produced.

In this comparative example, the Abbe number was 23, which was in an acceptable range, and the shrinkage ratio at the time of curing was 3.3%, which was sufficiently low. However, the viscosity was 2200 mPa·s, which was high, and the transmittance was 80%, which was relatively low. The refractive index was 1.620, which was high.

### Example 3

The difference from Example 1 was as follows.
(A) First (meth)acrylate [Formula (2)]: 5 parts by weight
(B) Second (meth)acrylate [Formula (12)]: 90 parts by weight
(C) Third (meth)acrylate [Formula (17)]: 5 parts by weight

In this example, all of the following components (A), (B), (C), and (E) were mixed together to obtain a resin composition. The lens substrate was disposed on this resin composition. Irradiation with ultraviolet rays allowed the photopolymerization initiator to initiate polymerization of the components (A), (B), and (C), and the components (A), (B), (C), and (E) were cured through polymerization on the lens substrate to form a resin layer. Thus, the composite optical element of Example 3 was produced.

In this example, the refractive index was 1.605 and the Abbe number was 25, which were in an acceptable range. The shrinkage ratio at the time of curing was 4.0%, which was sufficiently low. The viscosity was 1000 mPa·s, which was sufficiently low. The transmittance was 85%, which was sufficiently high.

### Example 4

The difference from Example 1 was as follows.
(A) First (meth)acrylate [Formula (2)]: 40 parts by weight
(B) Second (meth)acrylate [Formula (12)]: 50 parts by weight
(C) Third (meth)acrylate [Formula (17)]: 10 parts by weight

In this example, all of the following components (A), (B), (C), and (E) were mixed together to obtain a resin composition. The lens substrate was disposed on this resin composition. Irradiation with ultraviolet rays allowed the photopolymerization initiator to initiate polymerization of the components (A), (B), and (C), and the components (A), (B), (C), and (E) were cured through polymerization on the lens substrate to form a resin layer. Thus, the composite optical element of Example 4 was produced.

In this example, the refractive index was 1.615 and the Abbe number was 23, which were in an acceptable range. The shrinkage ratio at the time of curing was 3.2%, which was sufficiently low. The viscosity was 2000 mPa·s, which was sufficiently low. The transmittance was 83%, which was sufficiently high.

### Comparative Example 3

The difference from Example 1 was as follows.
(A) First (meth)acrylate [Formula (2)]: 2 parts by weight
(B) Second (meth)acrylate [Formula (12)]: 88 parts by weight
(C) Third (meth)acrylate [Formula (17)]: 10 parts by weight

In this comparative example, all of the following components (A), (B), (C), and (E) were mixed together to obtain a resin composition. The lens substrate was disposed on this resin composition. Irradiation with ultraviolet rays allowed the photopolymerization initiator to initiate polymerization of the components (A), (B), and (C), and the components (A), (B), (C), and (E) were cured through polymerization on the lens substrate to form a resin layer. Thus, the composite optical element of Comparative Example 3 was produced.

In this comparative example, the refractive index was 1.600 and the Abbe number was 28, which were in an acceptable range. The viscosity was 500 mPa·s, which was sufficiently low, and the transmittance was 85.5%, which was sufficiently high. However, the shrinkage ratio at the time of curing was 4.5%, which was high.

### Comparative Example 4

The difference from Example 1 was as follows.
(A) First (meth)acrylate [Formula (2)]: 45 parts by weight
(B) Second (meth)acrylate [Formula (12)]: 45 parts by weight
(C) Third (meth)acrylate [Formula (17)]: 10 parts by weight

In this comparative example, all of the following components (A), (B), (C), and (E) were mixed together to obtain a resin composition. The lens substrate was disposed on this resin composition. Irradiation with ultraviolet rays allowed the photopolymerization initiator to initiate polymerization of the components (A), (B), and (C), and the components (A), (B), (C), and (E) were cured through polymerization on the lens substrate to form a resin layer. Thus, the composite optical element of Comparative Example 4 was produced.

In this comparative example, the refractive index was 1.615 and the Abbe number was 23, which were in an acceptable range. The shrinkage ratio at the time of curing was 3.8%, which was sufficiently low. However, the viscosity was 2500 mPa·s, which was high, and the transmittance was 80%, which was low.

### Example 5

The difference from Example 1 was as follows.
(A) First (meth)acrylate [Formula (2)]: 8 parts by weight
(B) Second (meth)acrylate [Formula (12)]: 82 parts by weight
(D) Fourth (meth)acrylate [Formula (23)]: 10 parts by weight

In this example, all of the following components (A), (B), (D), and (E) were mixed together to obtain a resin composition. The lens substrate was disposed on this resin composition. Irradiation with ultraviolet rays allowed the photopolymerization initiator to initiate polymerization of the components (A), (B), and (D), and the components (A), (B), (D), and (E) were cured through polymerization on the lens substrate to form a resin layer. Thus, the composite optical element of Example 5 was produced.

In this example, the refractive index was 1.604 and the Abbe number was 26.5, which were in an acceptable range. The shrinkage ratio at the time of curing was 3.5%, which was sufficiently low. The viscosity was 1500 mPa·s, which was sufficiently low. The transmittance was 85%, which was sufficiently high.

### Example 6

The difference from Example 1 was as follows.
(A) First (meth)acrylate [Formula (2)]: 35 parts by weight
(B) Second (meth)acrylate [Formula (12)]: 55 parts by weight
(D) Fourth (meth)acrylate [Formula (23)]: 10 parts by weight

In this example, all of the following components (A), (B), (D), and (E) were mixed together to obtain a resin composition. The lens substrate was disposed on this resin composition. Irradiation with ultraviolet rays allowed the photopolymerization initiator to initiate polymerization of the components (A), (B), and (D), and the components (A), (B), (D), and (E) were cured through polymerization on the lens substrate to form a resin layer. Thus, the composite optical element of Example 6 was produced.

In this example, the refractive index was 1.612 and the Abbe number was 25, which were in an acceptable range. The shrinkage ratio at the time of curing was 3.0%, which was sufficiently low. The viscosity was 2000 mPa·s, which was sufficiently low. The transmittance was 83%, which was sufficiently high.

### Comparative Example 5

The difference from Example 1 was as follows.
(A) First (meth)acrylate [Formula (2)]: 2 parts by weight
(B) Second (meth)acrylate [Formula (12)]: 88 parts by weight
(D) Fourth (meth)acrylate [Formula (23)]: 10 parts by weight

In this comparative example, all of the following components (A), (B), (D), and (E) were mixed together to obtain a resin composition. The lens substrate was disposed on this resin composition. Irradiation with ultraviolet rays allowed the photopolymerization initiator to initiate polymerization of the components (A), (B), and (D), and the components (A), (B), (D), and (E) were cured through polymerization on the lens substrate to form a resin layer. Thus, the composite optical element of Comparative Example 5 was produced.

In this comparative example, the refractive index was 1.600 and the Abbe number was 27.8, which were in an acceptable range. The viscosity was 350mPa·s, which was sufficiently low, and the transmittance was 85.5%, which was sufficiently high. However, the shrinkage ratio at the time of curing was 4.6%, which was high.

### Comparative Example 6

The difference from Example 1 was as follows.
(A) First (meth)acrylate [Formula (2)]: 45 parts by weight
(B) Second (meth)acrylate [Formula (12)]: 45 parts by weight
(D) Fourth (meth)acrylate [Formula (23)]: 10 parts by weight

In this comparative example, all of the following components (A), (B),(D), and (E) were mixed together to obtain a resin composition. The lens substrate was disposed on this resin composition. Irradiation with ultraviolet rays allowed the photopolymerization initiator to initiate polymerization of the components (A), (B), and (D), and the components (A), (B), (D), and (E) were cured through polymerization on the lens substrate to form a resin layer. Thus, the composite optical element of Comparative Example 6 was produced.

In this comparative example, the refractive index was 1.616 and the Abbe number was 23, which were in an acceptable range. The shrinkage ratio at the time of curing was 3.0%, which was sufficiently low. However, the viscosity was 2500 mPa·s, which was high, and the transmittance was 80%, which was low.

### Example 7

The difference from Example 1 was as follows.
(A) First (meth)acrylate [Formula (2)]: 5 parts by weight
(B) Second (meth)acrylate [Formula (12)]: 75 parts by weight
(C) Third (meth)acrylate [Formula (17)]: 10 parts by weight
(D) Fourth (meth)acrylate [Formula (23)]: 10 parts by weight

In this example, all of the following components (A), (B), (C), (D), and (E) were mixed together to obtain a resin composition. The lens substrate was disposed on this resin composition. Irradiation with ultraviolet rays allowed the photopolymerization initiator to initiate polymerization of the components (A), (B), (C), and (D), and the components (A), (B), (C), (D), and (E) were cured through polymerization on the lens substrate to form a resin layer. Thus, the composite optical element of Example 7 was produced.

In this example, the refractive index was 1.605 and the Abbe number was 25, which were in an acceptable range. The shrinkage ratio at the time of curing was 3.9%, which was sufficiently low. The viscosity was 950 mPa·s, which was sufficiently low. The transmittance was 85%, which was sufficiently high.

### Example 8

The difference from Example 1 was as follows.
(A) First (meth)acrylate [Formula (2)]: 40 parts by weight
(B) Second (meth)acrylate [Formula (12)]: 40 parts by weight
(C) Third (meth)acrylate [Formula (17)]: 10 parts by weight
(D) Fourth (meth)acrylate [Formula (23)]: 10 parts by weight

In this example, all of the following components (A), (B), (C), (D), and (E) were mixed together to obtain a resin composition. The lens substrate was disposed on this resin composition. Irradiation with ultraviolet rays allowed the photopolymerization initiator to initiate polymerization of the components (A), (B), (C), and (D), and the components (A), (B), (C), (D), and (E) were cured through polymerization on the lens substrate to form a resin layer. Thus, the composite optical element of Example 8 was produced.

In this example, the refractive index was 1.618 and the Abbe number was 23.3, which were in an acceptable range. The shrinkage ratio at the time of curing was 3.1%, which was sufficiently low. The viscosity was 2000 mPa·s, which was sufficiently low. The transmittance was 83%, which was sufficiently high.

### Comparative Example 7

The difference from Example 1 was as follows.
(A) First (meth)acrylate [Formula (2)]: 2 parts by weight
(B) Second (meth)acrylate [Formula (12)]: 78 parts by weight
(C) Third (meth)acrylate [Formula (17)]: 10 parts by weight
(D) Fourth (meth)acrylate [Formula (23)]: 10 parts by weight

In this comparative example, all of the following components (A), (B), (C), (D), and (E) were mixed together to obtain a resin composition. The lens substrate was disposed on this resin composition. Irradiation with ultraviolet rays allowed the photopolymerization initiator to initiate polymerization of the components (A), (B), (C), and (D), and the components (A), (B), (C), (D), and (E) were cured through polymerization on the lens substrate to form a resin layer. Thus, the composite optical element of Comparative Example 7 was produced.

In this comparative example, the refractive index was 1.600 and the Abbe number was 27.5, which were in an acceptable range. The viscosity was 350 mPa·s, which was sufficiently low, and the transmittance was 85.5%, which was sufficiently high. However, the shrinkage ratio at the time of curing was 4.6%, which was high.

### Comparative Example 8

The difference from Example 1 was as follows.
(A) First (meth)acrylate [Formula (2)]: 45 parts by weight
(B) Second (meth)acrylate [Formula (12)]: 35 parts by weight
(C) Third (meth)acrylate [Formula (17)]: 10 parts by weight
(D) Fourth (meth)acrylate [Formula (23)]: 10 parts by weight

In this comparative example, all of the following components (A), (B), (C), (D), and (E) were mixed together to obtain a resin composition. The lens substrate was disposed on this resin composition. Irradiation with ultraviolet rays allowed the photopolymerization initiator to initiate polymerization of the components (A), (B), (C), and (D), and the components (A), (B), (C), (D), and (E) were cured through polymerization on the lens substrate to form a resin layer. Thus, the composite optical element of Comparative Example 8 was produced.

In this comparative example, the refractive index was 1.614 and the Abbe number was 23, which were in an acceptable range. The shrinkage ratio at the time of curing was 3.3%, which was sufficiently low. However, the viscosity was 2500 mPa·s, which was high, and the transmittance was 80%, which was low.

### Example 9

The difference from Example 1 was as follows.
(A) First (meth)acrylate [Formula (2)]: 5 parts by weight
(B) Second (meth)acrylate [Formula (12)]: 95 parts by weight
(E) Photopolymerization initiator KIP150 (manufactured by Lamberti)

In this example, all of the following components (A), (B), and (E) were mixed together to obtain a resin composition. The lens substrate was disposed on this resin composition. Irradiation with ultraviolet rays allowed the photopolymerization initiator to initiate polymerization of the components (A) and (B), and the components (A), (B) and (E) were cured through polymerization on the lens substrate to form a resin layer. Thus, the composite optical element of Example 9 was produced.

In this example, the refractive index was 1.605 and the Abbe number was 25, which were in an acceptable range. The shrinkage ratio at the time of curing was 4.0%, which was sufficiently low. The viscosity was 200 mPa·s, which was sufficiently low. The transmittance was 88%, which was sufficiently high. Further, as shown in Table 2, the transmittance of the produced composite optical element after being allowed to stand at 85° C. for 500 hours was 88%, which showed no deterioration.

### Example 10

The difference from Example 1 was as follows.
(A) First (meth)acrylate [Formula (2)]: 35 parts by weight
(B) Second (meth)acrylate [Formula (12)]: 65 parts by weight
(E) Photopolymerization initiator KIP150 (manufactured by Lamberti)

In this example, all of the following components (A), (B), and (E) were mixed together to obtain a resin composition. The lens substrate was disposed on this resin composition. Irradiation with ultraviolet rays allowed the photopolymerization initiator to initiate polymerization of the components (A) and (B), and the components (A), (B) and (E) were cured through polymerization on the lens substrate to form a resin layer. Thus, the composite optical element of Example 10 was produced.

In this example, the refractive index was 1.610 and the Abbe number was 23.8, which were in an acceptable range. The shrinkage ratio at the time of curing was 3.0%, which was sufficiently low. The viscosity was 1500 mPa·s, which was sufficiently low. The transmittance was 85%, which was sufficiently high.

### Example 11

The difference from Example 1 was as follows.
(A) First (meth)acrylate [Formula (2)]: 10 parts by weight
(B) Second (meth)acrylate [Formula (12)]: 90 parts by weight

In this example, all of the following components (A), (B), and (E) were mixed together to obtain a resin composition. The lens substrate was disposed on this resin composition. Irradiation with ultraviolet rays allowed the photopolymerization initiator to initiate polymerization of the components (A) and (B), and the components (A), (B) and (E) were cured through polymerization on the lens substrate to form a resin layer. Thus, the composite optical element of Example 11 was produced.

In this example, the refractive index was 1.607 and the Abbe number was 25, which were in an acceptable range. The shrinkage ratio at the time of curing was 3.0%, which was sufficiently low. The viscosity was 300 mPa·s, which was sufficiently low. The transmittance was 85%, which was sufficiently high.

### Comparative Example 9

The difference from Example 1 was as follows.
(A) First (meth)acrylate [Formula (2)]: 20 parts by weight
(F) Alicyclic diacrylate [Formula (25)]: 80 parts by weight

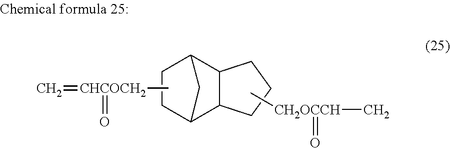

In this comparative example, all of the following components (A), (E), and (F) were mixed together to obtain a resin composition. The lens substrate was disposed on this resin composition. Irradiation with ultraviolet rays allowed the photopolymerization initiator to initiate polymerization of the components (A) and (F), and the components (A), (E) and (F) were cured through polymerization on the lens substrate to form a resin layer. Thus, the composite optical element of Comparative Example 9 was produced.

In this comparative example, the shrinkage ratio at the time of curing was 3.8%, which was sufficiently low. The viscosity was 800 mPa·s, which was sufficiently low. The transmittance was 86%, which was sufficiently high. However, the refractive index was 1.5497, which was low, and the Abbe number was 39, which was high.

### Comparative Example 10

The difference from Example 1 was as follows.
(A) First (meth)acrylate [Formula (2)]: 20 parts by weight
(G) Aliphatic triacrylate [Formula (26)]: 80 parts by weight

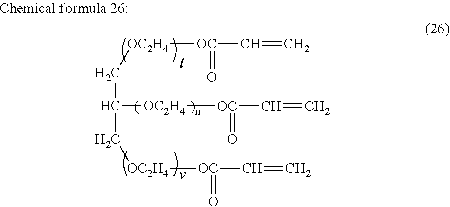

In this comparative example, all of the following components (A), (E), and (G) were mixed together to obtain a resin composition. The lens substrate was disposed on this resin composition. Irradiation with ultraviolet rays allowed the photopolymerization initiator to initiate polymerization of the components (A) and (G), and the components (A), (E) and (G) were cured through polymerization on the lens substrate to form a resin layer. Thus, the composite optical element of Comparative Example 10 was produced.

In this comparative example, the viscosity was 600 mPa·s, which was sufficiently low, and the transmittance was 85%, which was sufficiently high. However, the shrinkage ratio at the time of curing was 5.0%, which was high. The refractive index was 1.5278, which was low, and the Abbe number was 44, which was high.

### Comparative Example 11

The difference from Example 1 was as follows.
(A) First (meth)acrylate [Formula (2)]: 10 parts by weight
(H) Acrylate having a phenyl group [Formula (27)]: 90 parts by weight

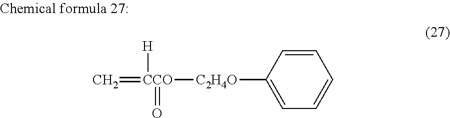

In this comparative example, all of the following components (A), (E), and (H) were mixed together to obtain a resin composition. The lens substrate was disposed on this resin composition. Irradiation with ultraviolet rays allowed the photopolymerization initiator to initiate polymerization of the components (A) and (H), and the components (A), (E) and (H) were cured through polymerization on the lens substrate to form a resin layer. Thus, the composite optical element of Comparative Example 11 was produced.

In this comparative example, the shrinkage ratio at the time of curing was 3.2%, which was sufficiently low, and the transmittance was 85%, which was high. However, the viscosity was 13 mPa·s, which was low. The refractive index was 1.5661, which was low, and the Abbe number was 35, which was high.

TABLE 1

| | First | Second | Third | Fourth | Photopoly- | Photopoly- | | | Shrinkage | | Transmit- |
|---|---|---|---|---|---|---|---|---|---|---|---|
| Ex./C. | (meth) | (meth) | (meth) | (meth) | merization | merization | Refractive | Abbe | ratio at the | Viscosity | tance at |
| Ex. Nos. | acrylate | acrylate | acrylate | acrylate | initiator A | initiator B | index | number | time of curing | (mPa · s) | 400 nm |
| Ex. 1 | 8 | 92 | 0 | 0 | 3 | — | 1.6060 | 25.5 | 3.6 | 250 | 85 |
| Ex. 2 | 35 | 65 | 0 | 0 | 3 | — | 1.6100 | 23.8 | 3.0 | 1500 | 84 |
| C. Ex. 1 | 2 | 98 | 0 | 0 | 3 | — | 1.6000 | 28 | 4.5 | 200 | 85.5 |
| C. Ex. 2 | 45 | 55 | 0 | 0 | 3 | — | 1.6200 | 23 | 3.3 | 2200 | 80 |
| Ex. 3 | 5 | 90 | 5 | 0 | 3 | — | 1.605 | 25 | 4.0 | 1000 | 85 |
| Ex. 4 | 40 | 50 | 10 | 0 | 3 | — | 1.615 | 23 | 3.2 | 2000 | 83 |
| C. Ex. 3 | 2 | 88 | 10 | 0 | 3 | — | 1.6000 | 28 | 4.5 | 500 | 85.5 |
| C. Ex. 4 | 45 | 45 | 10 | 0 | 3 | — | 1.615 | 23 | 3.8 | 2500 | 80 |
| Ex. 5 | 8 | 82 | 0 | 10 | 3 | — | 1.604 | 26.5 | 3.5 | 1500 | 85 |
| Ex. 6 | 35 | 55 | 0 | 10 | 3 | — | 1.612 | 25 | 3.0 | 2000 | 83 |
| C. Ex. 5 | 2 | 88 | 0 | 10 | 3 | — | 1.600 | 27.8 | 4.6 | 350 | 85.5 |
| C. Ex. 6 | 45 | 45 | 0 | 10 | 3 | — | 1.616 | 23 | 3.0 | 2500 | 80 |
| Ex. 7 | 5 | 75 | 10 | 10 | 3 | — | 1.605 | 25 | 3.9 | 950 | 85 |
| Ex. 8 | 40 | 40 | 10 | 10 | 3 | — | 1.618 | 23.3 | 3.1 | 2000 | 83 |
| C. Ex. 7 | 2 | 78 | 10 | 10 | 3 | — | 1.600 | 27.5 | 4.6 | 350 | 85.5 |
| C. Ex. 8 | 45 | 35 | 10 | 10 | 3 | — | 1.614 | 23 | 3.3 | 2500 | 80 |
| Ex. 9 | 5 | 95 | 0 | 0 | — | 3 | 1.605 | 25.0 | 4.0 | 200 | 88 |
| Ex. 10 | 35 | 65 | 0 | 0 | — | 3 | 1.610 | 23.8 | 3.0 | 1500 | 85 |
| Ex. 11 | 10 | 90 | 0 | 0 | 3 | — | 1.607 | 25 | 3.0 | 300 | 85 |
| C. Ex. 9 | 20 | 0 | 0 | 0 | 3 | — | 1.5497 | 39 | 3.8 | 800 | 86 |
| C. Ex. 10 | 20 | 0 | 0 | 0 | 3 | — | 1.5278 | 44 | 5.0 | 600 | 85 |
| C. Ex. 11 | 10 | 0 | 0 | 0 | 3 | — | 1.5661 | 35 | 3.2 | 13 | 85 |

Photopolymerization initiator
A: Irgacure 754
B: KIP150

TABLE 2

| | First | Second | Third | Fourth | Photopoly- | | | Shrinkage | | | |
|---|---|---|---|---|---|---|---|---|---|---|---|
| | (meth) | (meth) | (meth) | (meth) | merization | Refractive | Abbe | ratio at the | Viscosity | Transmittance | Transmittance |
| Ex. Nos. | acrylate | acrylate | acrylate | acrylate | initiator | index | number | time of curing | (mPa · sec) | at 400 nm | (85° C., 500 h) |
| Ex. 1 | 8 | 92 | 0 | 0 | A | 1.6060 | 25.5 | 3.6 | 250 | 85 | 83 |
| Ex. 9 | 5 | 95 | 0 | 0 | B | 1.605 | 25.0 | 4.0 | 200 | 88 | 88 |

A: Irgacure 754
B: KIP150

The above-mentioned examples and comparative examples revealed the following.
(1) A resin composition having low viscosity and a low shrinkage ratio at the time of curing while satisfying desired optical constants was obtained by using: (A) first (meth)acrylate; and (B) second (meth)acrylate, and setting the content of (A) first (meth)acrylate to 4 to 42 wt %, as in Examples 1 and 2.
(2) A resin composition having low viscosity and a low shrinkage ratio at the time of curing while satisfying desired optical constants was obtained by using: (C) third (meth)acrylate, in addition to (A) first (meth)acrylate and (B) second (meth)acrylate, and setting the content of (A) first (meth)acrylate to 4 to 42 wt %, as in Examples 3 and 4.
(3) A resin composition having low viscosity and a low shrinkage ratio at the time of curing while satisfying desired optical constants was obtained by using: (D) fourth (meth)acrylate, in addition to (A) first (meth)acrylate and (B) second (meth)acrylate, and setting the content of (A) first (meth)acrylate to 4 to 42 wt %, as in Examples 5 and 6.
(4) A resin composition having low viscosity and a low shrinkage ratio at the time of curing while satisfying desired optical constants was obtained by using: (C) third (meth)acrylate; and (D) fourth (meth)acrylate, in addition to (A) first (meth)acrylate and (B) second (meth)acrylate, and setting the content of (A) first (meth)acrylate to 4 to 42 wt %, as in Examples 7 and 8.
(5) The high temperature reliability can be improved by using a hydroxyketone compound having a molecular weight of at least 250 but not more than 2000 as a polymerization initiator, as in Examples 9 and 10.

The invention may be embodied in other forms without departing from the spirit or essential characteristics thereof. The embodiments disclosed in this specification are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

The composite optical element of the present invention can be applied to lenses for cameras/video cameras, lenses for projectors, lenses for optical discs (such as CD and DVD), etc.

1-11. (canceled)

12. A composite optical element comprising:
a lens substrate; and
a resin layer stacked on the lens substrate,
wherein the resin layer is formed of a cured product of a composition comprising:
a first (meth)acrylate having a fluorene skeleton; and
a second (meth)acrylate having a biphenyl ring but having no hydroxyl group, and
a content of the first (meth)acrylate in the composition is from 5 to 38 wt %.

13. The composite optical element according to claim 12, wherein the content of the first (meth)acrylate in the composition is from 7 to 35 wt %.

14. The composite optical element according to claim 12,
wherein the composition further comprises a third (meth)acrylate having a polyfunctional isocyanurate skeleton.

15. The composite optical element according to claim 12,
wherein the composition further comprises a fourth (meth)acrylate having a biphenyl ring and a hydroxyl group.

16. The composite optical element according to claim 12, wherein the resin layer satisfies a following formula:
1.600≦nd≦1.615 and 22≦vd≦28,
where nd is a refractive index of the resin layer, and vd is an Abbe number thereof.

17. The composite optical element according to claim 12, wherein the lens substrate is made of glass.
